(19) United States
(12) Patent Application Publication
(10) Pub. No.: US 2022/0067458 A1
(43) Pub. Date: Mar. 3, 2022

(54) SMART METADATA MAPPING FOR SENSOR DATA

(71) Applicant: International Business Machines Corporation, Armonk, NY (US)

(72) Inventors: Xinlin WANG, Irvine, CA (US); Rachel Lea JARVIE, Durham, NC (US); Qingyan WANG, Sudbury, MA (US); Yajin ZHENG, Acton, MA (US)

(21) Appl. No.: 17/008,938

(22) Filed: Sep. 1, 2020

(51) Int. Cl. G06K 9/62; G06N 20/00

(52) U.S. Cl. CPC G06K 9/6296; G06N 20/00; G06K 9/6289; G06K 9/623

(57) ABSTRACT

A method for mapping sensor data to a plurality of properties comprises acquiring sensor data from a sensor, and training a first classification model using data values of sample sensor data to identify patterns for each of the plurality of properties. Each of the patterns corresponds to a different one of the plurality of properties. The method further comprises training a second classification model using a mapping of variables to property types of the sample data to identify associations between the variables and the plurality of properties, and associating subsets of the sensor data with the plurality of properties by processing the sensor data with the first classification model and the second classification model.

### BACKGROUND

Computing systems utilize various sensors to monitor elements of external systems. For example, computer systems utilize sensors to monitor elements of engines, wind turbines, gas lines, water pipes, and power generation systems, among others. However, in order to consume the sensor data in a downstream application, e.g., an asset management system or the like, the computing system needs to know the semantic meaning of the sensor data that can be represented by a set of metadata. In current implementations, a user is asked to manually complete the mapping between sensor data and metadata. Further, anytime a sensor is added to a system, a user is required to manually update the mapping between sensor data and metadata. However, as many computing systems may utilize hundreds or more sensors, this process is time intensive and repetitive, resulting in a decreased user experience and longer initialization times for the computing systems.

Thus, there is a need for an improved computing system that is able to map sensor data to metadata without relying on user input.

### SUMMARY

In one example, a method for mapping sensor data to a plurality of properties comprises acquiring sensor data from a sensor, and training a first classification model using data values of sample sensor data to identify patterns for each of the plurality of properties. Each of the patterns corresponds to a different one of the plurality of properties. The method further comprises training a second classification model using a mapping of variables to property types of the sample data to identify associations between the variables and the plurality of properties, and associating subsets of the sensor data with the plurality of properties by processing the sensor data with the first classification model and the second classification model.

In one example, a computing device comprises a communication unit configured to acquire sensor data from a sensor. The computing device further comprises a mapping manager configured to associate subsets of the sensor data with a plurality of properties by processing the sensor data with a first classification model and a second classification model. The first classification model is trained using values of sample sensor data to identify sensor patterns. Each of the sensor patterns corresponds to a different one of a plurality of properties. The second classification model is trained based on a mapping of sensor variables to property types of the sample data to identify variable names associated with the plurality of properties.

In one example, a computer program product for mapping sensor data to a property comprises a computer-readable storage medium having computer-readable program code embodied therewith. The computer-readable program code executable by one or more computer processors to receive sensor data from a plurality of sensors, and associate subsets of the sensor data with a plurality of properties by processing the sensor data with a first classification model and a second classification model. The first classification model is trained using values of sample sensor data to identify sensor patterns corresponding to different ones of a plurality of properties. The second classification model is trained based on a mapping of sensor variables to property types of the sample data to identify associations between variables and the plurality of properties.

### BRIEF DESCRIPTION OF THE SEVERAL VIEWS OF THE DRAWINGS

FIG. 1 illustrate an example computing system, according to one or more embodiments.

FIG. 2A illustrates example data, according to one or more embodiments.

FIG. 2B illustrates example data, according to one or more embodiments.

FIG. 3 illustrates example data, according to one or more embodiments.

FIG. 4 illustrates an example method of assigning sensor data with a property, according to one or more embodiments.

FIG. 5 illustrates an example method of assigning sensor data with a property, according to one or more embodiments.

### DETAILED DESCRIPTION

A property (“meter”) associated with metadata is automatically assigned to sensor data such that the sensor data may be communicated to an application in which an associated meter is processed. A computing device builds one or more models that are used to evaluate the sensor data to map the sensor data to one or more properties (meters). The sensor data is assigned to meters automatically utilizing the one or more models, mitigating the need for user input. Accordingly, the efficiency at which sensor data is assigned to meters based on corresponding properties is increased and the reliance on user input is decreased.

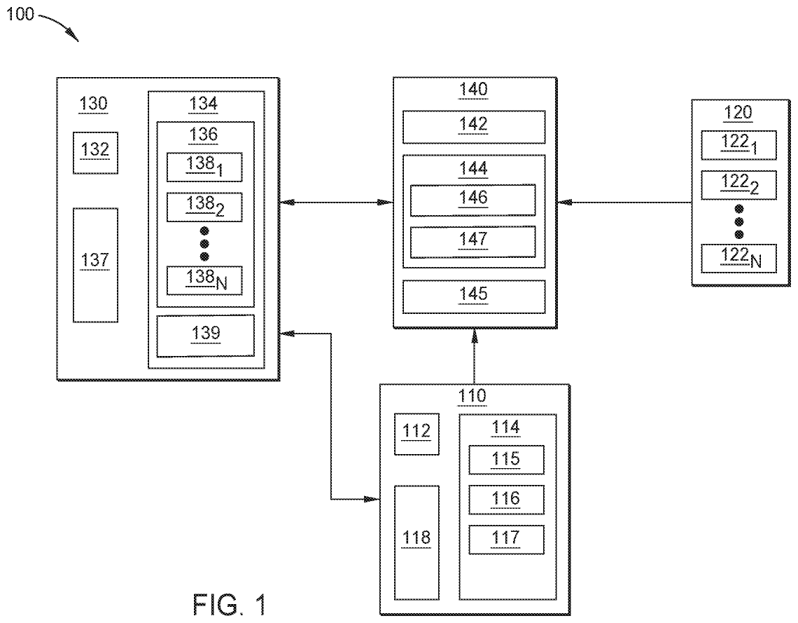

FIG. 1 illustrates a block diagram of a mapping system 110, a sensor system 120, an asset management system 130, and a messaging system 140. Each of the mapping system 110, the sensor system 120, the asset management system 130, and the messaging system 140 may be referred to as a computer system. Further, one or more of the mapping system 110, the sensor system 120, the asset management system 130, and the messaging system 140 may be combined into a single computer system.

The mapping system 110 is a personal computing device, a mobile computing device, an edge computing device, or a cloud computing device, among others. The mapping system 110 is connected with the sensor system 120, the asset management system 130, and/or the messaging system 140.

The mapping system 110 includes a processor 112. The processor 112 may be a general computing processing device, such as a central processing unit (CPU). The mapping system 110 further includes a memory 114. The memory 114 is communicatively connected with the processor 112 and includes a mapping generator (e.g., mapping generator program) 115. The memory 114 is a computer readable storage medium. For example, the memory 114 is a tangible device that can retain and store instructions (computer readable program instructions) to be executed by the processor 112. The memory 114 is an electronic storage device, a magnetic storage device, an optical storage device, an electromagnetic storage device, a semiconductor storage device, or any suitable combination of the foregoing.

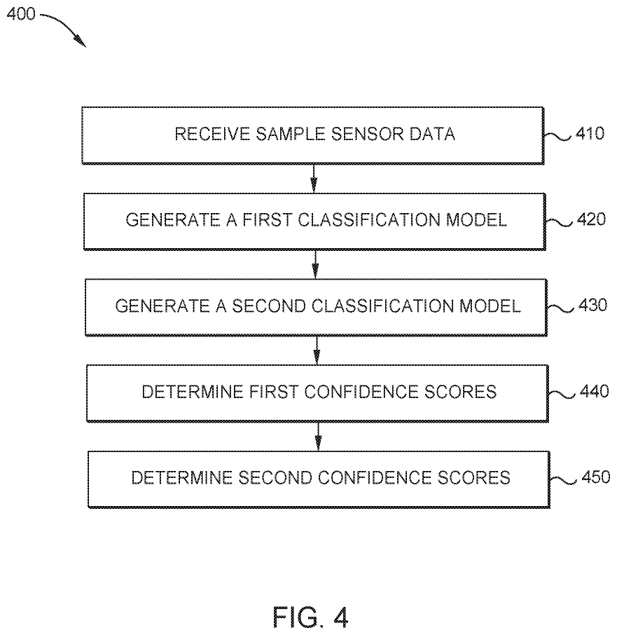

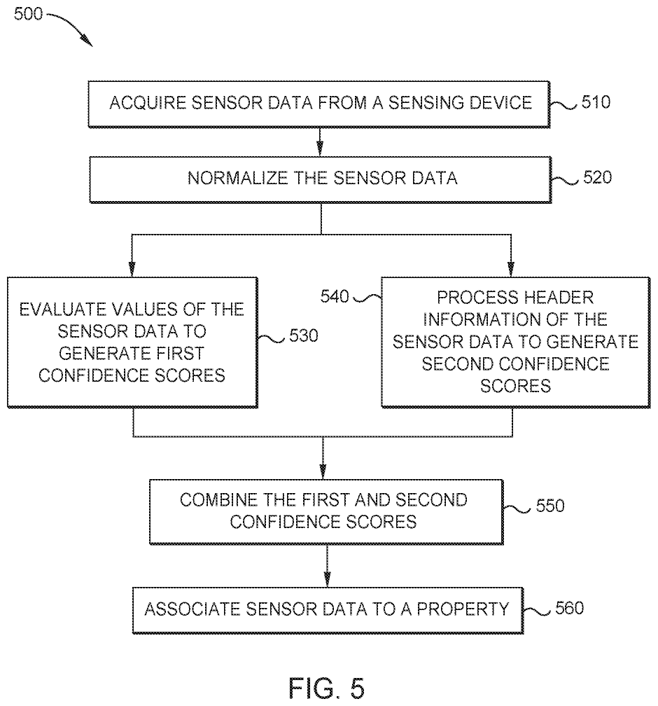

The mapping generator 115 is an application that includes computer readable program instructions that are executed by the processor 112. For example, and as will be described in further detail with regard to FIGS. 4 and 5, when executed by the processor 112, the mapping generator 115 generates a mapping (e.g., a mapping 146) between attributes and/or meters and a sensor payload received from the sensor system 120.

The memory 114 further includes a first classification model 116 and a second classification model 117, both of which will be described in more detail in the following.

The mapping system 110 further includes a communication unit 118. The communication unit 118 controls the communication between the mapping system 110 and the sensor system 120, the asset management system 130, and/or the messaging system 140. For example, the communication unit 118 receives a payload of sensor data from the sensor system 120. In one embodiment, the communication unit 118 may be a wireless communications device. For example, the communication unit 118 is a Bluetooth communication unit or a wireless local area network (WLAN) communication unit. In another embodiment, the communication unit 118 is a wired communication unit. In such embodiments, the communication unit 118 is a local area network (LAN) device.

The sensor system 120 includes one or more sensors that acquire and provide sensor data to the mapping system 110, the messaging system 140, and/or the asset management system 130. The sensor system 120 comprises sensors 122. The sensors 122 monitor one or more external devices (e.g., motors, pumps, pipes, and turbines, etc.) to acquire the sensor data. For example, the sensor system 120 may include one or more sensors configured to acquire acceleration data, temperature data, vibration data, and/or pressure data, among others. The sensor system 120 may be referred to as an internet of things (IoT) device. The sensor system 120 communicates a payload of sensor data to the mapping system 110 and/or messaging system 140. The sensor system 120 communicates with the mapping system 110 and/or the messaging system 140 via a wireless connection (e.g., WLAN or Bluetooth) or a wired connection (e.g., LAN).

The sensor system 120 may include one or more sensors. For example, the computing system 100 may include sensors 122₁-122ₙ, where N is 2 or more. Further, the sensors of sensor system 120 may monitor one or more external devices. Each sensor may monitor the same external device or first at least one sensor monitors a first external device and a second at least one sensor monitors a second external device. The payload provided by the sensor system 120 includes sensor data provided by one or more the sensors 122₁-122ₙ.

The mapping generator 115 is executed by the processor 112 to evaluate the sensor data received from the sensor system 120. For example, as will be described in greater detail in the following, the mapping generator 115 evaluates the sensor data of the payload provided by the sensor system 120 with a first classification model 116 and a second classification model 117 to assign a property 138 (e.g., a meter) to one or more data streams and/or variable streams of the sensor data, and generates a mapping 146. The mapping 146 maps at least a portion of the sensor data of the payload received from the sensor system 120 to one of the properties 138 of the asset management system 130. The mapping generator 115 communicates the mapping 146 to the messaging system 140 and stores the mapping 146 in the memory 144 of the messaging system 140. The mapping generator 115 may communicate the mapping 146 to the messaging system 140 each time a mapping is created and/or updated, in response to a request provided by the messaging system 140 and/or the asset management system 130, and/or in response to receiving a payload of sensor data from the sensor system 120. The mapping 146 may include an association between one or more meters and/or properties to a pattern of values and/or variables.

While only a single asset management system 130 is shown in FIG. 1, multiple asset management systems 130 may be coupled to the mapping system 110 and/or the messaging system 140. Further, additionally or alternatively, multiple sensor systems 120 may be connected to the mapping system 110 and/or the messaging system 140. In such embodiments, a different mapping 146 may be generated for each sensor system 120 and/or asset management system 130 connected to the mapping generator 115. Further, a mapping 146 may be generated for each combination of asset management system 130 and sensor system 120 connected to the mapping system 110.

The asset management system 130 includes controller 132, a memory 134, and the communication unit 137. The controller 132 may be a general computing processing device, such as a central processing unit (CPU). The memory 134 is communicatively coupled with the controller 132. The memory 134 is a computer readable storage medium. For example, the memory 134 is a tangible device that can retain and store instructions (computer readable program instructions) to be executed by the controller 132. The memory 134 is an electronic storage device, a magnetic storage device, an optical storage device, an electromagnetic storage device, a semiconductor storage device, or any suitable combination of the foregoing.

The memory 134 includes the asset manager 136. The asset manager 136 is an application that comprises instructions that are executable on the controller 132. The asset manager 136 includes properties (meters) 138. The asset manager 136 includes one or more properties 138. For example, as illustrated in FIG. 1, the asset manager 136 includes properties 138₁, 138₂, . . . 138_{N}, where N is three or more. The sensor data associated with each of properties 138 is processed by the asset manager 136 to determine one or more properties of a corresponding device or system (e.g., a device monitored by the sensor system 120). The properties 138 are mapped to at least a subset of the sensor data within a payload provided by a sensor system 120 such that the sensor data may be processed to determine one or more properties of a device being monitored. For example, the sensor data is processed to determine temperature information, velocity information, pressure information, and/or acceleration information, etc. The processed sensor data may be utilized by the asset manager 136 to monitor a device (or an asset) and determine the functionality of the device (e.g., is the device operating within expected or normal operating parameters). The processed sensor data may be communicated to another computer system for further processing and/or utilization.

The communication unit 137 communicates with the mapping system 110 and the messaging system 140. For example, the communication unit 137 communicates mapping information to the mapping system 110 and data requests to the messaging system 140, and receives mapped sensor data from the messaging system 140. For example, the communication unit 137 communicates metadata, and/or mapping 139 to the mapping system 110. The metadata may provide an indication as to the variables and/or attributes (e.g., labels, header names, identifies, etc.) values that are associated with each property 138. For example, for a property associated with temperature, the metadata may include one or more variables such as temperature, temp, T, Celsius, and/or Fahrenheit. The mapping 139 includes mapping information between sensor data and an attribute or attributes associated with one or more of the properties 138.

The communication unit 137 may be a wireless communications device that is wirelessly connected with the mapping system 110 and/or messaging system 140. For example, the communication unit 137 is a Bluetooth communication unit or a wireless local area network (WLAN) communication unit. In another embodiment, the communication unit 137 is wired communication unit. In such embodiments, the communication unit 137 is a local area network (LAN) device.

The messaging system 140 is connected between the asset management system 130 and the sensor system 120. The messaging system 140 receives a payload of sensor data from the sensor system 120 and communicates mapped sensor data to the asset management system 130. The mapped sensor data may include one or more subsets of the sensor data that are each associated with one of the properties 138. The messaging system 140 may receive a request for sensor data from the asset management system 130 and, in response to receipt of the request, requests a payload data from the sensor system 120. As will be described in greater detail in the following, the messaging system generates the mapped sensor data based on the mapping 146.

The messaging system 140 includes processor 142, memory 144, and communication unit 145. The memory 144 includes mapping 146 and the mapping manager 147. The memory 144 is communicatively connected with the processor 142. The memory 144 is a computer readable storage medium. For example, the memory 144 is a tangible device that can retain and store instructions (computer readable program instructions) to be executed by the processor 142. The memory 144 is an electronic storage device, a magnetic storage device, an optical storage device, an electromagnetic storage device, a semiconductor storage device, or any suitable combination of the foregoing. The communication unit 145 may be a wired (LAN) or wireless (WLAN or Bluetooth, among others) communication unit. The mapping 146 is provided by the mapping system 110 and contains rules of how to map the sensor data received from the sensor system 120 with the properties provided by the asset management system 130. The mapping manager 147 is an application comprising instructions executed by the processor 142 and that when executed by the processor 142 cause the processor 142 to process the payload received from the sensor system 120 to map the sensor data of the payload to properties provided by the asset management system 130. Further, the messaging system 140 utilizes the mapping 146 to communicate the requested sensor data to the asset management system 130. For example, the messaging system 140 processes the payload received from the sensor system 120 with the mapping 146 to identify the sensor data requested by the asset management system 130.

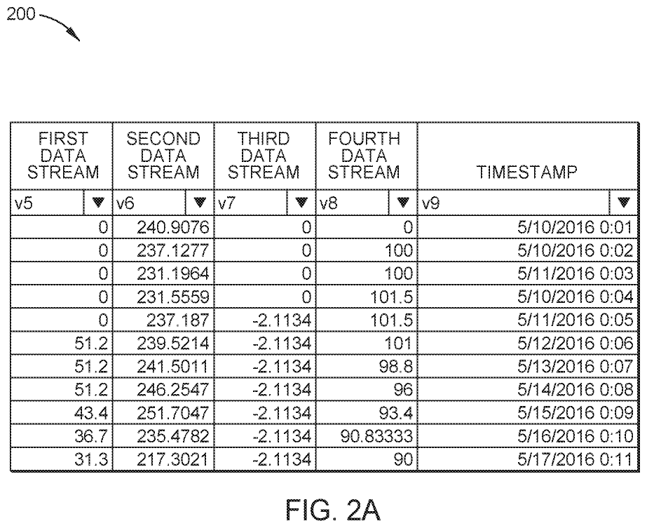

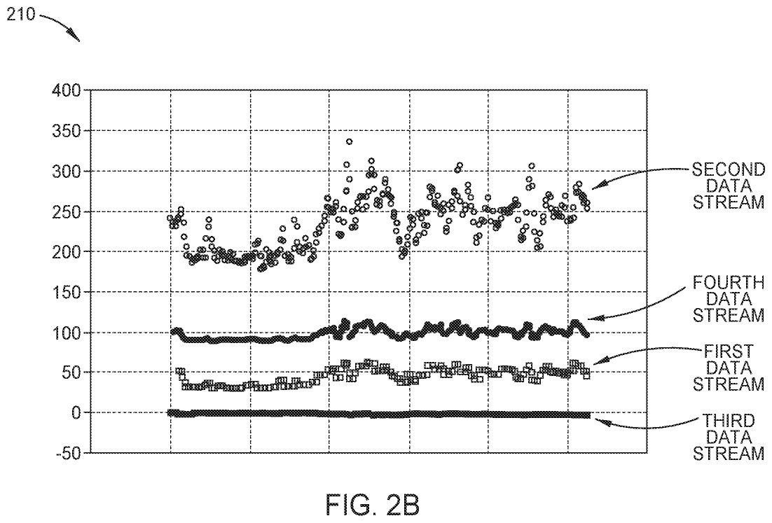

FIG. 2A illustrates an example payload 200 provided by the sensor system 120. As illustrated, the payload 200 includes four data streams (e.g., a first data stream, a second data stream, a third data stream, and a fourth data stream) and timestamp information. The data steams may be provided by one or more of the sensors 122. Each of the data streams is associated with a different one of the sensors 122. Alternatively, two or more of the data streams are associated with a common one of the sensors 122. However, the sensor data within the payload is difficult to interpret as the labels and/or identifiers used by the sensors 122 may not align with those used by the properties 138. Thus, there is a need for a system that can generate map the sensor data of the payload to the properties associated with the properties 138 such that the appropriate sensor data can be communicated to each property 138 for processing. FIG. 2B is graph 210 illustrating the values of first, second, third, and fourth data streams over time (e.g., the timestamp).

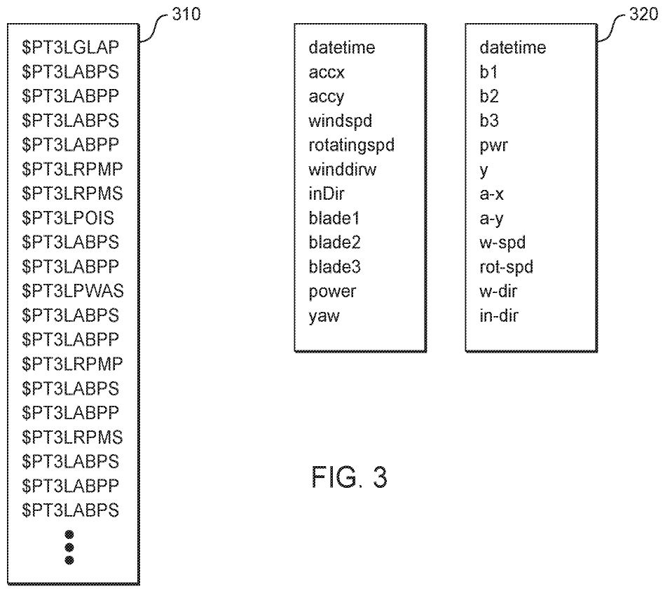

FIG. 3 illustrates example streams of variables and/or attributes (e.g., labels, header names, identifiers, etc.) of payloads 310 and 320. The variables and/or attributes provided in each payload may differ between different sensors 122. Accordingly, the asset management system 130 is unable to associate the data corresponding the streams of variables and/or attributes with the properties 138 to process the sensor data.

To associate sensor data with the properties 138, the mapping system 110 utilizes the first classification model 116 and the second classification model 117 to generate a mapping 146. The mapping system 110 utilizes one more machine learning techniques to train, or build, the first classification model 116 and the second classification model 117 based on sample sensor data.

FIG. 4 illustrates method 400 for determining a mapping to map sensor data to one or more properties 138, according to one or more embodiments. At block 410, the mapping system 110 receives sample sensor data and the mapping generator 115 is executed by the processor 112 to perform machine learning (or data mining) on the sample sensor data to generate classification models. The sample sensor data may be for different properties (e.g., different ones of the properties 138). The sample sensor data may be provided by the sensor system 120, the asset management system 130, and/or an external device (e.g., an asset, a device manufacturer, etc.).

The sample sensor data includes sample sensor data corresponding to different properties. For example, the sample sensor data includes sample sensor data for an acceleration property, sample sensor data for a temperature property, sample sensor data for a vibration property, sample sensor data for an optical property, and/or sample sensor data for a property, among others. The sample data also includes variables and/or attributes (e.g., labels, header names, identifiers, etc.) associating sample data with properties.

The mapping generator 115 analyzes the sample sensor data for each property to determine a pattern. For example, the sample sensor data is analyzed to identify a pattern of the first classification model 116 or the second classification model 117. The first classification model 116 includes a pattern for each of the properties 138. Further, the second classification model 117 includes a pattern for each of the properties 138.

At block 420, the mapping generator 115 is executed on the processor 112 to perform machine learning on the sample sensor data to identify patterns within the sensor data to generate a first classification model 116. The first classification model 116 is utilized by the mapping generator 115 to associate subsets (e.g., data streams) the sensor data with the properties 138. To generate the first classification model 116, the values of the sample sensor data are analyzed to identify patterns within the sensor data. Machine learning is performed on the values of the sample sensor to identify one or more patterns within the sensor data. Sensor data associated with different types of sensors is associated with different ones of the patterns. The patterns are associated to the values of the sensor data falling within an identified range of values, values that increase over a time period, and/or values that decrease over a time period, among others. As is illustrated in FIG. 2, the sensor data for the different properties includes corresponding sensor values. Analyzing the sensor data identifies a pattern within the sensor values for a property. For example, analyzing the sensor data for each property identifies a pattern where the sensor values fall between an upper and lower threshold value. The upper and lower threshold values are different for each property type. In one embodiment, a first one of the properties 138 is associated with a first lower threshold value and a first upper threshold value. A second one of the properties 138 is associated with a second lower threshold value and a second upper threshold value. The first lower threshold value is less than the second lower threshold value and the first upper threshold value is less than the second upper threshold value. In other embodiments, other patterns may be additionally, or alternatively, determined from the sample sensor data. For example, the patterns may correspond to a deviation amount from a mean or median value of the sensor values of sample data for a property 138. The mean or median value and/or the deviation amount differs for each property 138. Further, the patterns may correspond to the type of variable names within the sensor data. Identifying a pattern of variable names includes identifying repeating strings of letters and a frequency of the appearance of the identified repeating string of letters.

At block 430, the mapping generator 115 is executed on the processor 112 to perform machine learning on the sample sensor data to identify variables associated with the properties 138 to generate the second classification model 117. The second classification model 117 is utilized by the mapping generator 115 to classify the sensor data. To generate the second classification model 117, the metadata and/or header information of the sample sensor data is analyzed to identify variables and/or attributes (e.g., labels, header names, identifiers, etc.) associated with the sample sensor data of each property 138. Machine learning is applied to the metadata and/or header information of the sample sensor to identify the variables and/or attributes that associated with each of the properties 138. Identifying variables may comprise collecting variables (labels, header names, identifiers, etc.) within the header information and/or metadata sensor data associated with the properties 138. Analyzing the sensor data comprises analyzing the metadata and/or header information to identify the variables and/or attributes for each of the properties 138. For example, for a temperature sensor, labels such as “T,” “Temp,” “Fahrenheit,” “Celsius,” or “Kelvin,” among others, are used to identify the sensor data. Further, analyzing the metadata and/or header information identifies that for an acceleration sensor, labels such as “A,” “Acc,” “Acce,” or “Acceleration,” among others, are used to identify the sensor data. The frequency at which the different variable names may be determined, and the variable names that are most frequently utilized for each property are utilized to generate the second classification model.

In various embodiments, the mapping generator 115 analyzes the sample data to detect anomalous data, or anomalies, within the sample data. For example, the mapping generator 115 is executed by the processor 112 to analyze the sample data for each property to detect anomalous data. The anomalous data may be greater or less than an average or median value by a threshold value. After a pattern has been identified, sample sensor data that has a value that is less than a lower threshold or a percentage of the lower threshold of the pattern is determined to anomalous data. The percentage may be in a range of about 50 percent to about 100 percent. Further, sample sensor data that has a value that is greater than an upper threshold or a percentage of the upper threshold of the pattern is determined to anomalous data. The percentage may be in a range of about 100 percent to about 150 percent.

A mapping based on the first classification model 116 and the second classification model 117 is stored within the memory 144 as the mapping 146. For example, the mapping system 110 communicates the first classification model 116 and the second classification model 117 to the messaging system 140 and the first classification model 116 and the second classification model 117 are stored as the mapping 146 within the memory 144. The mapping 146 may include the first classification model 116 and the second classification model 117 that indicate which subset (e.g., data stream) of sensor data is associated with which property. For example, the mapping 146 includes patterns identified by the first classification model 116 and variables identified by the second classification model 117. The mapping 146 may include a first rule indicating that data which is associated within a first range of values is mapped to a first property. Further, the mapping 146 may include rules that associate variables with different properties. The rules may be generated based on confidence scores generated as described in the following blocks 440 and/or 450. For example, the mapping generator 115 ranks the first confidence scores and keyword classification confidence scores and selects the property associated with the highest ranked confidence scores. In one embodiment, the mapping generator 115 combines the first confidence scores and keyword classification confidence scores, and determines a property of the combined confidence scores.

At block 440, the mapping manager 147 is executed by the processor 142 to compare the sensor data of a payload received from the sensor system 120 to the first classification model 116 to determine first confidence scores. The messaging system 140 compares the values of the sensor data of a payload to the first classification model 116 to identify a corresponding property or properties. For example, the messaging system 140 compares the values of the sensor data to the patterns of the first classification model 116 to associate subsets of the sensor data with one or more of the properties 138. The messaging system 140 compares the values of the sensor data to lower and upper thresholds of a first pattern associated with a first one of the properties 138 to determine if the sensor data is within the bounds of the first pattern and corresponds to the first property.

The mapping manager 147 determines a confidence score based on the degree that the sensor values match each pattern of the first classification model 116. A confidence score is generated for each relationship (e.g., mapping) between the sensor data and the properties 138 based on the associated pattern. The confidence score corresponds to the number of sensor values that are determined to match a pattern. For example, the confidence score corresponds to the number of sensor values that are determined to be between an upper threshold and lower threshold value of the pattern. The mapping manager 147 determines a confidence score for each relationship between sensor data and the properties 138 by comparing the sensor data to each of the patterns of the first classification model 116. The confidence score may be represented by a percentage. For example, each confidence score may be in a range of about 0 percent to about 100 percent. Confidence scores closer to 0 percent indicate a low confidence and that the mapping between associated the sensor data and a property has a low probability of being correct. Further, confidence scores closer to 100 percent indicate a high confidence and that the mapping between associated sensor data and a property has a high probability of being correct.

At block 450, the mapping manager 147 is executed by the processor 142 to compare the header information and/or metadata of the sensor data of a payload provided by the sensor system 120 to the second classification model 117 to determine keyword classification confidence scores. The mapping manager 147 compares the metadata or header data of the sensor data to the second classification model to determine keyword classification confidence scores for a relationship (e.g., mapping or association, etc.) between the sensor data and each property. The confidence scores correspond to the degree of accuracy of the mapping of the variables (e.g., labels, header names, identifiers, etc.) of the sensor data to the properties within the second classification model 117. The confidence score may be represented by a percentage. For example, each confidence score may be in a range of about 0 percent to about 100 percent. Confidence scores closer to 0 percent indicate a lower confidence and that the mapping between a variable (e.g., label, identifier, etc.) and a property has a low probability of being correct. Further, confidence scores closer to 100 percent indicate a high confidence and that the mapping between a label (e.g., a variable) and a property has a high probability of being correct.

The mapping 146 associates one or more of the properties 138 with one or more data streams (e.g., subsets of the sensor data) within a payload provided by the sensor system 120. For example, the mapping 146 associates property “pressure” to a first one of the data streams (e.g., a first subset of the sensor data) within a payload, property “velocity” to a second one of the data streams (e.g., a second subset of the sensor data) within the payload, and/or property “temperature” to a third one of the data streams (e.g., a third subset of the sensor data) within the payload.

In one embodiment, the mapping generator 115 performs the blocks 440 and/or 450 based on sensor data and/or sample data to confirm the accuracy of the first classification model 116 and the second classification model 117. For example, the mapping generation 115 compares sensor data and/or sample data against the first classification model 116 and the second classification model 117 to determine first classification scores and second classification scores for associations between properties and data streams (e.g., subsets) of sensor data. The first classification model 116 and the second classification model 117 may be determined to be accurate (e.g., effective at associations between properties and data streams) in response to a high confidence association between properties and data streams. Further, first classification model 116 and the second classification model 117 may be determined to be accurate when no more than one association between a property and data stream is determined to be of high confidence (e.g., above a threshold level).

FIG. 5 illustrates a method 500 for mapping sensor data to one or more properties 138, according to one or more embodiments. At block 510, the messaging system 140 receives sensor data from the sensor system 120. The sensor data may be in the form a sensor payload as illustrated in FIG. 2. The asset manager 130 may also receive the sensor data from the sensor system 120. At block 520, the mapping manager 147 is executed by the controller 132 to normalize the sensor data. Normalizing the sensor data identifies the sensor values, variable names and/or other metadata within the sensor data. In one embodiment, the block 520 may be omitted from the method 500.

At block 530, the mapping manager 147 is executed by the processor 142 to evaluate the values of the sensor data against the first classification model 116 to determine first confidence scores. The mapping manager 147 determines a confidence score for the sensor data for each of the properties for which there is a pattern within first classification model 116. The confidence score identifies the degree that the sensor data is likely to be provided by a particular sensor. Further, the confidence scores may range from 0 percent to 100 percent.

At block 540 the mapping manager 147 processes the header information (and/or metadata) of the sensor data with the mapping 146 to identify one or more associations between variables (labels, header names, identifies, etc.) of the sensor data with the properties 138. The mapping generator 115 processes the header information of the sensor data using the second classification model. The mapping generator 115 processes header information (and/or metadata) of the sensor data against the second classification models associated with each of the properties 138 to determine corresponding classification confidence scores. In one embodiment, a fuzzy search is applied to identify and map variables to a property. The second classification confidence scores illustrate the probability that a mapping between a variable and a property 138 is correct. High confidence scores correspond to a higher probability that a mapping is correct while low confidence scores correspond to a low probability that a mapping is correct.

At block 550, the mapping manager 147 combines the first and second confidence scores. For example, a total confidence score may be determined from the first and second confidence scores. The total confidence score may be a linear combination of the first and second confidence scores. For example, the first and second confidence scores for each property may be added to together or multiplied together, or combined in some other way, to determine the total confidence score. Further, one or more of the first and second confidence scores for each sensor may be weighted such that one of the first and second confidence scores accounts for a larger portion of the total confidence score. The mapping manager 147 may rank the properties based on the total confidence score.

In one or more embodiments, a prompt may be output (e.g., displayed) requesting that a mapping between properties 138 and sensor data be selected. A user may be presented with the highest ranking mappings to select from. The mapping 146 may be updated based on the selected mapping.

At block 580, the mapping manager 147 is executed by the processor 142 to associate a data stream (e.g., subset) of the sensor data with a property 138 based on highest ranking confidence score determined from the mapping 146. For example, the mapping manager 147 determines an association between a first data stream (e.g., subset) of sensor data and the property 138₁ based on a highest ranking confidence score and the messaging system 140 communicates the association to the asset management system 130. The messaging system 140 may further communicate the sensor data or a portion of the sensor data to the asset management system 130. In one example, the mapping manager 147 determines that an association between the first data stream of FIG. 2A and the property 138₁ has a highest confidence score, and the messaging system 140 transmits that association to the asset management system 130. Further, the messaging system 140 communicates the data of the first data stream and/or the entirety of the corresponding sensor data to the asset management system 130.

The identified association between a data stream (e.g., a subset) of sensor data is communicated to the asset management system 130 and the corresponding sensor data is processed by the asset manager 136 to determine one or more parameters for an external device (e.g., asset) or environment. For example, in embodiments where the association is between a temperature property and a first data stream, the first data stream is processed by the asset manager 136 to determine a temperature parameter or a change in temperature parameter of an asset.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method for mapping sensor data to a plurality of properties, the method comprising:
acquiring sensor data from a sensor;
training a first classification model using data values of sample sensor data to identify patterns for each of the plurality of properties, wherein each of the patterns corresponds to a different one of the plurality of properties;
training a second classification model using a mapping of variables to property types of the sample data to identify associations between the variables and the plurality of properties; and
associating subsets of the sensor data with the plurality of properties by processing the sensor data with the first classification model and the second classification model.

2. The method of claim 1, wherein processing the sensor data comprises:
determining a plurality of first confidence scores by evaluating the sensor data with the first classification model, wherein each of the plurality of first confidence scores associates the sensor data with the plurality of properties; and
determining a plurality of second confidence scores by processing the sensor data with the second classification model, wherein each of the plurality of second confidence scores associates the sensor data with the plurality of properties.

3. The method of claim 2 further comprising:
generating a plurality of combined confidence scores by combining the plurality of first confidence scores with the plurality of second confidence scores.

4. The method of claim 2, wherein a first property of the plurality of properties is associated with at least one of a highest ranked one of the plurality of first confidence scores and a highest ranked one of the plurality of second confidence scores.

5. The method of claim 1, wherein each of the patterns has an associated upper threshold value and an associated lower threshold value.

6. The method of claim 1 further comprising:
generating a mapping based on the first classification model and the second classification model.

7. The method of claim 1 further comprising:
processing a first subset of the subsets of the sensor data based on a first property of the plurality of properties.

8. A computing device comprising:
a communication unit configured to acquire sensor data from a sensor; and
a mapping manager configured to:
associate subsets of the sensor data with a plurality of properties by processing the sensor data with a first classification model and a second classification model, wherein the first classification model is trained using values of sample sensor data to identify sensor patterns, wherein each of the sensor patterns corresponds to a different one of a plurality of properties, and the second classification model is trained based on a mapping of sensor variables to property types of the sample data to identify variable names associated with the plurality of properties.

9. The computing device of claim 8, wherein the mapping manager is further configured to:
determine a plurality of first confidence scores by evaluating the sensor data with the first classification model, wherein each of the plurality of first confidence scores associates the sensor data with the plurality of properties; and
determine a plurality of second confidence scores by processing the sensor data with the second classification model, wherein each of the plurality of second confidence scores associates the sensor data with the plurality of properties.

10. The computing device of claim 9, wherein the mapping manager is further configured to:
generate a plurality of combined confidence scores by combining the plurality of first confidence scores with the plurality of second confidence scores.

11. The computing device of claim 9, wherein a first property of the plurality of properties is associated with at least one of a highest ranked one of the plurality of first confidence scores and a highest ranked one of the plurality of second confidence scores.

12. The computing device of claim 8, wherein each of the sensor patterns has an associated upper threshold value and an associated lower threshold value.

13. The computing device of claim 8, wherein the mapping manager is further configured receive a mapping based on the first classification model and the second classification model.

14. The computing device of claim 8, wherein the subsets of the sensor data are communicated to asset manager configured to process the subsets of the sensor data based on the plurality of properties.

15. A computer program product for mapping sensor data to a property, the computer program product comprising:
a computer-readable storage medium having computer-readable program code embodied therewith, the computer-readable program code executable by one or more computer processors to:
receive sensor data from a plurality of sensors; and
associate subsets of the sensor data with a plurality of properties by processing the sensor data with a first classification model and a second classification model, wherein the first classification model is trained using values of sample sensor data to identify sensor patterns corresponding to different ones of a plurality of properties, and the second classification model is trained based on a mapping of sensor variables to property types of the sample data to identify associations between variables and the plurality of properties.

16. The computer program product of claim 15, wherein the computer-readable program code is further executable to:
determine a plurality of first confidence scores by evaluating the sensor data with the first classification model, wherein the plurality of first confidence scores associates the subsets of the sensor data with a different one of the plurality of properties; and
determine a plurality of second confidence scores by processing the sensor data with the second classification model, wherein each of the plurality of second confidence scores associates the subsets of the sensor data with the plurality of properties.

17. The computer program product of claim 16, wherein the computer-readable program code is further executable to:
generate a plurality of combined confidence scores by combining the plurality of first confidence scores with the plurality of second confidence scores.

18. The computer program product of claim 16, wherein a first property of the plurality of properties is associated with at least one of a highest ranked one of the plurality of first confidence scores and a highest ranked one of the plurality of second confidence scores.

19. The computer program product claim 15, wherein a first subset of the subsets of the sensor data is processed based on a first property of the plurality of properties.

20. The computer program product of claim 15, wherein each of the sensor patterns has an associated upper threshold value and an associated lower threshold value.
